(19) United States
(12) Patent Application Publication
(10) Pub. No.: US 2025/0251363 A1
(43) Pub. Date: Aug. 7, 2025

(54) System and Methods for High Throughput Mass Spectrometry

(71) Applicant: DH Technologies Development Pte. Ltd., Singapore (SG)

(72) Inventors: Bradley B. SCHNEIDER, Bradford (CA); Chang LIU, Richmond HIll (CA); Stephen TATE, Barrie (CA)

(21) Appl. No.: 18/856,897

(22) PCT Filed: Apr. 14, 2023
(86) PCT No.: PCT/IB2023/053808

§ 371 Date: Oct. 15, 2024

Related U.S. Application Data
(60) Provisional application No. 63/447,400, filed on Feb. 22, 2023.
(60) Provisional application No. 63/447,408, filed on Feb. 22, 2023.
(60) Provisional application No. 63/444,086, filed on Feb. 8, 2023.
(60) Provisional application No. 63/363,021, filed on Apr. 14, 2022.

(51) Int. Cl. G01N 27/623; H01J 49/00

(52) U.S. Cl. CPC G01N 27/623; H01J 49/0009

(57) ABSTRACT

System and method for high-throughput mass spectrometry are disclosed. In some embodiments the system comprises a sample introduction device, an ion source, an ion mobility separation device, a mass analyzer and a controller adapted to receive certain parameters from the IMSD and determine a mass range for more efficient operation of the mass analyzer. In some embodiments, the controller is adapted to provide data to, and receive data from other components to make the operation of the IMSD and the mass analyzer more efficient.

### RELATED APPLICATIONS

This application claims priority to U.S. provisional application No. 63/363,021, filed on Apr. 14, 2022, entitled “High Throughput Analysis using Ion Mobility and Mass Spectrometry,” claims priority to U.S. provisional application No. 63/444,086, filed on Feb. 8, 2023, entitled High-Throughput Analysis Using Ion Mobility and Mass Spectroscopy, claims priority to U.S. provisional application No. 63/447,400, filed on Feb. 22, 2023, entitled “Systems and Methods for High Throughput Mass Spectrometry,” and claims priority to U.S. provisional application No. 63/447,408, filed on Feb. 22, 2023, entitled “Systems and Methods for Sync of Instrument Voltages with Orthogonal Ion Pulsing.” These applications are incorporated herein by reference in their entirety.

### TECHNICAL FIELD

The present disclosure relates to mass spectrometry and more particularly to methods and systems for performing high-throughput mass spectrometry.

### BACKGROUND

Mass spectrometry (MS) is an analytical technique for determining the structure of test chemical substances with both qualitative and quantitative applications. MS may be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur.

Due to its high specificity, wide dynamic range and high sensitivity, MS has become one of the primary analytical platforms in high-throughput drug discovery to deliver high-fidelity and label-free analysis results. Various high-throughput mass spectrometer technologies have been developed in the past decades serving the needs of various drug discovery workflows, such as the million-compound-size high-throughput screening, High-throughput Adsorption, Distribution, Metabolism and Excretion/Elimination (ADME) screening, medicinal chemistry readout, compound Quality Control (QC), and bioanalysis.

To improve the analytical speed, various Liquid Chromatography (LC) free, high-throughput MS technologies have been developed in the past decade, such as Matrix Assisted Laser Desorption Ionization (MALDI), Laser Diode Thermal Desorption (LDTD), Matrix-Assisted Laser Desorption Electrospray Ionization (MALDESI), Acoustic Mist Ionization (AMI), Liquid Atmospheric Pressure Matrix-Assisted Laser Desorption/Ionization (LAP-MALDI), Desorption Electrospray Ionization (DESI), Direct Analysis in Real Time (DART), as well as the Acoustic Ejection Mass Spectrometry (AEMS) technology. The sample readout speed of 1-second-per-sample or even faster has been demonstrated.

However, there is still a need for improved methods and systems for performing high throughput mass spectrometry.

### SUMMARY

Some embodiments relate to a system for performing high throughput mass spectrometry, the system including: a controller configured to select a first set of system parameter values and determine a second set of system parameter values based on the first set of system parameter values, wherein: the first set of system parameter values is a set of mobility parameter values or a range of mass values, and the second set of system parameter values is: the set of mobility parameter values or the range of mass values, and different from the first set of system parameter values; an ion mobility separation device (IMSD) configured to: receive a plurality of ions from an upstream ion source; receive the set of mobility parameter values from the controller; and perform an ejection of a set of target ions of the plurality of ions by adjusting a set of mobility control parameters to the set of mobility parameter values; and a mass analyzer positioned downstream of the IMSD and configured to: receive the set of target ions; receive the range of mass values from the controller; and analyze the set of target ions by scanning the range of mass values or stepping across the range of mass values.

Some embodiments relate to a system, wherein the controller is configured to select the set of mobility parameter values and determine the range of mass values based on the set of mobility parameter values.

Some embodiments relate to a system, wherein the set of mobility parameter values includes at least one of a transmission window, a drift time, an ion mobility, a voltage, a differential ion mobility, a compensation voltage, a collision cross-section, a transport time, a gas flow rate, a gas composition, and a temperature of ions passing through the ion mobility separation device.

Some embodiments relate to a system, wherein the range of mass values includes one of ion masses within the transmission window, and expected fragments to be generated by the mass analyzer.

Some embodiments relate to a system, wherein the controller is configured to utilize calibration data corresponding to a correlation between the compensation voltage and an ion mass to compute the range of mass values or mobility values.

Some embodiments relate to a system, wherein the controller is configured to cause application of RF or DC voltages to the mass analyzer for setting the range of mass values.

Some embodiments relate to a system, wherein the controller is configured to update the range of mass values based on a change in the at least one of the set of mobility parameter values.

Some embodiments relate to a system, wherein the controller is configured to select the range of mass values and determine the set of mobility parameter values based on the range of mass values.

Some embodiments relate to a system, wherein the range of mass values include a first large range of mass or MRM transitions of interest and the at least one of the first or second set of parameters includes a smaller subset.

Some embodiments relate to a system, wherein the IMSD includes one of an ion mobility spectrometer and a differential mobility spectrometer.

Some embodiments relate to a system, wherein the mass analyzer is selected from a quadrupole mass analyzer, a time-of-flight mass analyzer, and an ion trap mass analyzer.

Some embodiments relate to a system, further including a sample introduction device for introducing a sample into an upstream ion source.

Some embodiments relate to a system, wherein the sample introduction device includes an open port interface (OPI).

Some embodiments relate to a method of performing high throughput mass spectrometry, the method including: introducing a plurality of ions into an ion mobility separation device (IMSD), adjusting at least one operational parameter of the IMSD to separate the plurality of ions based on ion mobility, and setting a mass range of a downstream mass analyzer configured to receive ions passing through the IMSD based on the at least one operation parameter of the ion mobility separation device.

Some embodiments relate to a method, wherein setting the mass range of the downstream mass analyzer includes utilizing calibration data indicative of a correlation between the at least one operational parameter of the IMSD and mass values of ions passing through the IMSD.

Some embodiments relate to a method of performing high throughput mass spectrometry, the method including: selecting, by a controller, a first set of system parameter values; determining, by the controller, a second set of system parameter values based on the first set of system parameter values, wherein: the first set of system parameter values is a set of mobility parameter values or a range of mass values, and the second set of system parameter values is: the set of mobility parameter values or the range of mass values, and different from the first set of system parameter values; receiving, by an ion mobility separation device (IMSD), a plurality of ions from an upstream ion source; performing an ejection of a set of target ions of the plurality of ions by adjusting a set of mobility control parameters to the set of mobility parameter values; receiving, by a mass analyzer, the set of target ions; and analyzing, by the mass analyzer, the set of target ions by scanning the range of mass values or stepping across the range of mass values.

Some embodiments relate to a method, wherein the controller is configured to select the set of mobility parameter values and determine the range of mass values based on the set of mobility parameter values.

Some embodiments relate to a method, wherein the set of mobility parameter values includes at least one of a transmission window, a drift time, an ion mobility, a voltage, a differential ion mobility, a compensation voltage, a collision cross-section, a transport time, a gas flow rate, a gas composition, and a temperature of ions passing through the ion mobility separation device.

Some embodiments relate to a method, wherein the range of mass values includes one of ion masses within the transmission window, and expected fragments to be generated by the mass analyzer.

Some embodiments relate to a method, wherein the controller is configured to utilize calibration data corresponding to a correlation between the compensation voltage and an ion mass to compute the range of mass values or mobility values.

Some embodiments relate to a method, wherein the controller is configured to cause application of RF or DC voltages to the mass analyzer for setting the range of mass values.

Some embodiments relate to a method, wherein the controller is configured to update the range of mass values based on a change in the at least one of the set of mobility parameter values.

Some embodiments relate to a method, wherein the controller is configured to select the range of mass values and determine the set of mobility parameter values based on the range of mass values.

Some embodiments relate to a method, wherein the range of mass values include a first large range of mass or MRM transitions of interest and the at least one of the first or second set of parameters includes a smaller subset.

Some embodiments relate to a method, wherein the IMSD includes one of an ion mobility spectrometer and a differential mobility spectrometer.

Some embodiments relate to a method, wherein the mass analyzer is selected from a quadrupole mass analyzer, a time-of-flight mass analyzer, and an ion trap mass analyzer.

Some embodiments relate to a method, further including a sample introduction device for introducing a sample into an upstream ion source.

Some embodiments relate to a method, wherein the sample introduction device includes an open port interface (OPI).

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

FIG. 1 schematically depicts a mass spectrometry system 100 according to various embodiments.

FIGS. 2A and 2B illustrate two flow charts depicting various steps of a method 200 for operating a high-throughput mass analysis device according to some embodiments.

FIG. 3 shows a schematic of a DMS 300 utilized in combination with a mass analyzer 370 according to some embodiments.

FIG. 4 schematically depicts an example of an implementation of a module 400 according to some embodiments.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

Various technologies for improving the speed of mass spectrometric analysis have been attempted. Although some of these technologies may provide a relatively high analysis speed at typically about 1-sec-per-sample or faster, these high-throughput mass spectrometry (MS) technologies do not provide additional ion separation beyond the mass-to-charge ratio for species discrimination. Therefore, such technologies cannot be utilized to distinguish an analyte of interest from its isomeric/isobaric interferences existing in the sample solution or generated from the in-source fragmentation, thus limiting the potential specificity and/or sensitivity for some assays.

When acquiring multidimensional data, the sample throughput may be limited by the time required for each analysis dimension. For instance, when combining ion mobility spectrometer (IMS) with mass spectrometer (MS), the throughput is limited by drift time in the first dimension and then mass analysis in the 2nd dimension. Alternatively, a differential mobility spectrometer (DMS) may be used along with the MS.

Determination of the optimized system parameters is critical for the DMS-MS or IMS-MS analysis, to achieve sufficient separation resolution without sacrificing too much sensitivity or analysis speed, especially for high-throughput applications. Optimized DMS or IMS parameters are typically dependent, at least in part, on sample type and the analytes of interest to be separated by the separation device. For IMS, the resolving power (peak position/FWHM) is related to the sensitivity and drift time. For example, in order to obtain higher resolving power, the sensitivity would decrease, and a longer cycle time would be necessary. For DMS the resolution is related to sensitivity and analysis/residence time in the DMS.

In various embodiments, the present disclosure provides methods and systems that utilize correlation between mobility data associated with a target ion, such as mobility drift time/cross section, and mass of that ion to define a range of m/z ratios for mass analysis of the ion after its passage through an ion mobility separation device, where the defined m/z range is reduced relative to a normal m/z range that would have been utilized for mass analysis of the ion. By way of example, there may be a presence of a correlation between mobility and mass for charged particles. By way of example, a correlation may exist between the ion mobility and the ion drift time in an IMS and the drift time may be used to reduce the total mass analysis range to an m/z range less than one that would normally be utilized, i.e., an m/z range that would be utilized without employing the correlation between an ion mobility and an ion mass.

Further, in embodiments in which a differential mobility spectrometer (DMS) is employed, the operational state and/or parameters of the DMS may be correlated with m/z ratios of the ions. By way of example, it has been discovered that in dry nitrogen transport gas, ions with m/z ratios less than 200 typically exhibit Type B behavior, where small CoV values may be observed. In such a case, there would be no need to configure the mass analyzer to scan for m/z ratios greater than 200. Conversely, multiply charged peptides may require the application of large positive CoV voltages (e.g., voltages greater than about 20 volts with separation voltages greater than 3000 V) in nitrogen transport gas for their passage through the DMS. Accordingly, in various embodiments, when such large CoV values are observed for ion passage through the DMS, the mass analyzer may be configured to scan for m/z ratios consistent with analysis of multiply charged peptides, e.g., m/z ratios greater than about 300-400. Hence, the operational parameters of the DMS may be utilized to set the scan range of a downstream mass analyzer, e.g., a mass filter utilized in an MS/MS mass spectrometer to select precursor ions for fragmentation.

Moreover, where running DMS with chemical modifiers, such as isopropyl alcohol (IPA), the magnitude of a negative CoV shift upon clustering of a target ion of interest with the modifier may depend on the relative mass of the target ion and that of the modifier. For example, the lower the m/z ratio of an ion, the larger is the negative CoV value. In various embodiments, such a relationship may be utilized to arrive at an m/z scan range for a mass analyzer positioned downstream of the DMS.

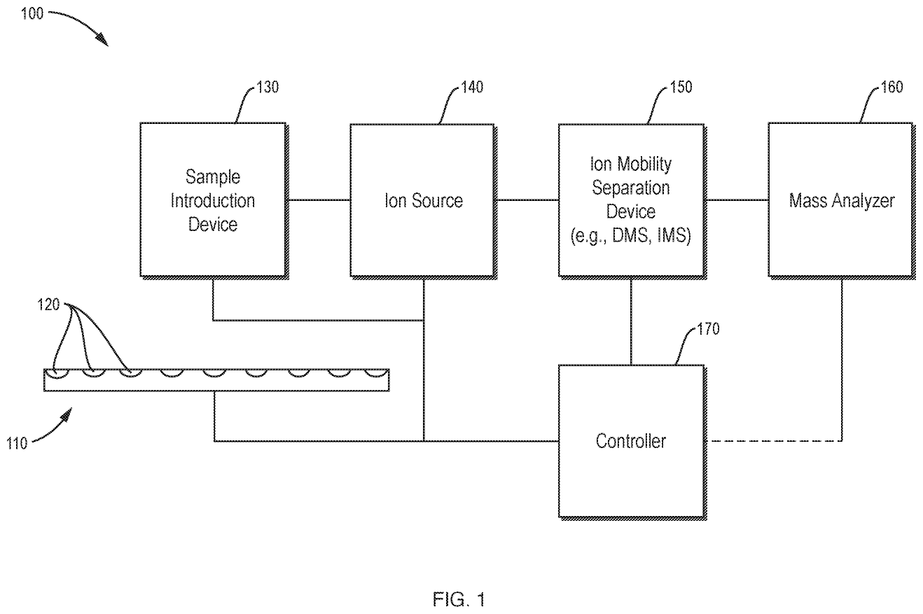

FIG. 1 schematically depicts a mass spectrometry system 100 according to various embodiments. System 100 includes a sample holding element 110 including one or more reservoirs 120, a sample introduction device 130, an ion source 140, an ion mobility separation device (IMSD) 150, a mass analyzer 160, and a controller 170.

Sample introduction device 130, e.g., an acoustic ejection system, is operably coupled to sample reservoirs 120 for causing the extraction of samples from those reservoirs and their delivery to a downstream ion source. Ion source 140, for each sample, ionizes at least one target analyte if present in that sample. In this fashion, ion source 140 generates a number of ions associated with that sample. The ions are in turn received by IMSD 150. In some embodiments, a sampling interface may be optionally positioned between sample introduction device 130 and ion source 140 to receive/dilute the samples sampled from the sample holding element. For example, an Open-Port Interface (OPI) may receive a sample ejected from a sample reservoir via acoustic ejection and may dilute and transfer the sample to a downstream ion source.

Mass analyzer 160 is configured to receive ions after they pass through IMSD 150 and provide a mass analysis of the ions. By way of example, mass analyzer 160 may be a quadrupole mass analyzer, a time-of-flight (ToF) mass analyzer, an ion trap mass analyzer, or a combination thereof, among others.

System 100 further includes a controller 170 configured to control and coordinate the operation of one or more parts of system 100, such as sample introduction device 130, ion source 140, IMSD 150, and mass analyzer 160. Controller 170 may also be in data communication with other parts such as the sample interface. In some embodiments, the controller may coordinate the operations of the IMSD and the mass analyzer to achieve faster and more accurate measurements, as detailed below.

IMSD 150 may be chosen from a variety of devices in various embodiments. By way of example, the IMSD may be any of an ion mobility spectrometer (IMS) or a differential mobility spectrometer (DMS) e.g., a field asymmetric waveform ion mobility spectrometer (FAIMS). The IMS may include any known device including a drift tube, travelling wave IMS, TIMS, or Differential Mobility Analyzer (DMA). The IMS drift region may be constructed from different types of structure including ring electrodes and circuit boards with any geometry including straight drift tubes, round drift tubes, oval shapes, or even right angle turns for space reduction. The DMS may include planar devices, cylindrical FAIMS, spherical FAIMS, or micromachined devices.

There may be a number of control parameters affecting the operation of IMSD 150. These parameters may be utilized by controller 170 to configure IMSD 150 to identify a target compound of interest. By way of example, the control parameters may provide at least one of an ion separation voltage, a compensation voltage and an offset voltage for application to a DMS positioned downstream of ion source 140 for receiving the ions generated by the ion source. By way of further example, the control parameter may be any of a dispersion voltage and a compensation voltage for application to the FAIMS.

In embodiments in which IMSD 150 is an ion mobility spectrometer (IMS), the control parameter may be, for example, specific potentials applied to various lens elements, potential gradients, travelling wave potentials, ramp rates, travelling wave amplitude, travelling wave ramp rate, travelling wave velocity, gas composition, number of cycles in the case of a cyclic IMS device, drift tube length details, control voltages for directing ions along parallel IMS devices, and gating times for shutters before and after an IMS device, among others.

IMSD 150 is utilized to address the limitation of lack of chromatographic separation. By using IMSD 150 an additional dimension of selectivity in addition to the m/z, which is determined by mass analyzer 160, may be utilized, e.g., to distinguish isomeric/isobaric compounds. A device such as an ion mobility spectrometry (IMS), or a differential mobility spectrometer (DMS) may be utilized to further expand the scope of mass analysis without adding much analysis time.

According to various embodiments, mass analyzer 160, positioned downstream of IMSD 150, may receive the ions after they pass through IMSD 150 and provide a mass analysis of the ions. In this fashion, system 100 provides multidimensional data using output data from both IMSD 150 and mass analyzer 160.

When acquiring multidimensional data, the sample throughput may be limited by the time required for each analysis dimension. For instance, DMS approaches require time to ramp the compensation voltage over a significant range of voltages. Additional time may be required to acquire mass analysis data for each step of the compensation voltage ramp. Accordingly, in some embodiments the parameter ramping process is carried out during a development stage. In actual sample analysis, the DMS may be operated at a fixed parameter. Accordingly, the DMS may be fast enough for the high-throughput analysis according to these embodiments. A similar scheme may be performed in an IMS-MS system whereby a parameter tuning development stage is performed on the IMS generating a corresponding mass range, and the results are employed for the mass analysis according to some embodiments.

Similarly, when combining IMS data with a mass analysis, the throughput is limited by drift time in the first dimension, i.e. the dimension determined by IMS data, and then mass analysis in the second dimension, i.e. the mass analyzer output data.

Accordingly, accurate determination of the optimized system parameters may be critical for both the DMS-MS or the IMS-MS analysis in order to achieve sufficient separation resolution without sacrificing too much sensitivity or analysis speed. This is particularly critical for high-throughput applications. Optimized DMS or IMS parameters depend typically, at least in part, on sample type and the analytes of interest to be separated by the separation device.

As a particular example, in the case of IMS, the resolving power (peak position/FWHM) is related to sensitivity and drift time. In order to obtain higher resolving power, the sensitivity would decrease, and a longer cycle time would be necessary. Similarly, for DMS, the resolution is related to sensitivity and analysis/residence time in the DMS.

It should be noted that, in conventional liquid chromatography LC-MS, the MS system executes continuous acquisition for the duration of the elution time of a single sample from a liquid chromatography (LC) column. The MS system may switch operational parameters during the elution time to match the expected analytes eluting at that particular point in the elution. Since in LC the elution time is typically over many minutes, and analytes are separated in time based on the solvent gradient being executed by the LC, the MS parameter switching may be matched to a delay time from the start of the elution based on an expected order of elution from the LC column.

In such LC-MS systems, acquisition data for different samples are typically reordered separately. Due to the extended time scale for LC-MS analysis (minutes), saving the existing data to a file and starting a new data file, which is in the order of seconds or less, does not typically cause a challenge for LC-MS systems.

For high-throughput analysis, however, with fast sampling-speed, each sampling event is on the order of seconds, with continuous 1 Hz sampling demonstrated for ADE-MS. Conventional techniques configure the MS to execute continuous acquisition while sampling a plurality of different samples. In this case, the MS signal from the plurality of sampling events is continuously captured and recorded as a single data file. Alternatively, the MS signal may be captured to separate files. The present embodiments disclose a high-throughput MS system that is capable of incorporating ion separation device 150, such as a DMS (e.g., FAIMS) and/or IMS separation device, in order to provide additional separation in combination with the mass selection of mass analyzer 160.

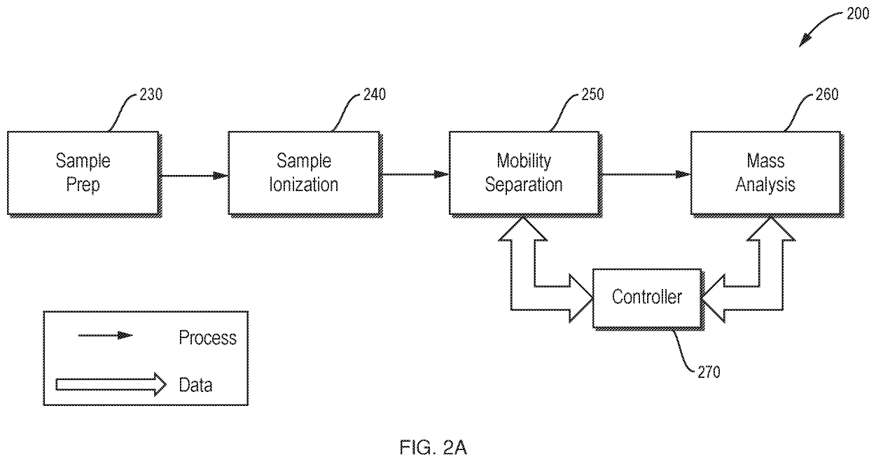

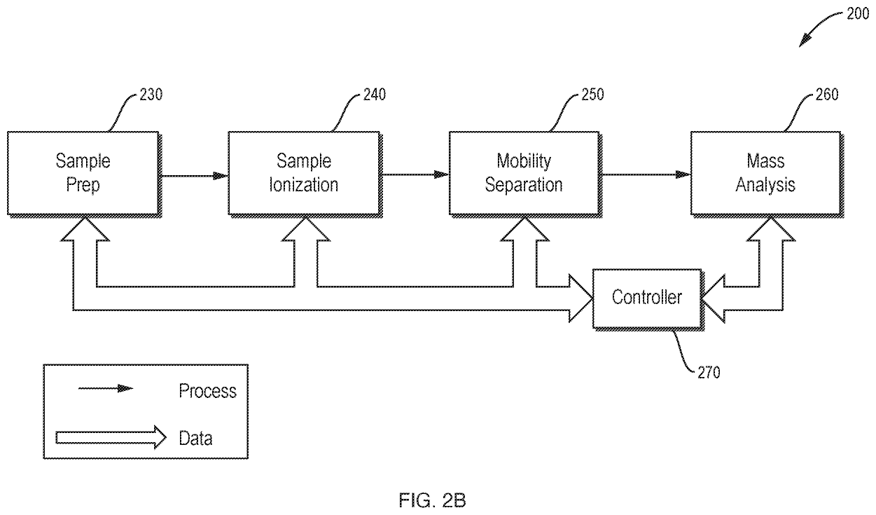

FIGS. 2A and 2B illustrate two flow charts depicting various steps of a method 200 for operating a high-throughput mass analysis device according to some embodiments.

At step 230, a sample contained in a sample holding element (herein also referred to as a sample holder) is sampled (i.e., extracted from the sample holder) for delivery to an ion source. In some embodiments, step 230 may include utilizing an energy source for removing the sample from the sample holding element. By way of example, the energy source may be any of a laser, an acoustic source, an ultrasound source and a source for providing pneumatic pressure and/or heat, among others. In some embodiments, an acoustic ejection of the sample contained in a reservoir is employed for extracting the sample from the reservoir for delivery to the ion source.

At step 240, the ion source ionizes the sample delivered to the ion source. The ion source ionizes at least one target analyte, when present in the sample, to generate a number of ions associated with that target analyte (herein also referred to as target compound). The ions are then transmitted to an IMSD.

At step 250, the IMSD separates the ions based on their mobilities. In this embodiment, the controller may set one or more operational parameters of IMSD to allow the passage of ions associated with the target analyte through the IMSD. By way of example, and without limitation, such operational parameters may include a Separation voltage (SV), a Compensation Voltage (CoV), a residence time for ions in the DMS cell, a Dispersion Voltage (DV)/CV for FAIMS, a Collision Cross Section (CCS)/drift time range for IMS, a drift path length for IMS, or a transport gas composition for IMS/DMS/FAIMS.

At step 260, the mass analyzer receives the target analytes from the IMSD and determines one or more characteristics related to their masses, for example, the m/z values. To that end, the controller may set an m/z scan range for the mass analyzer. The controller may set the range based on the one or more operational parameters of the IMSD utilized at step 250 and further based on a correlation between those operational parameters and the mass of the target ion. For example, as discussed above, when utilizing a DMS, the CoV value may be utilized to set the m/z scan range of the DMS. For example, when the CoV value exhibits a type B behavior, the controller may set the m/z scan range to be less than about 200.

As discussed above, in various embodiments, it will be beneficial for the system to include coordination of certain parameters and modes of operation between the IMSD, and the mass analyzer. This coordination is shown via the data lines (dual arrow) drawn between the controller and steps 250 and 260 in FIG. 2A, and FIG. 2B, whereby data and instructions are exchanged. In particular, FIG. 2A illustrates an implementation of controller 170 for the purpose of data and instructions exchange between IMSD 150, and mass analyzer 160 according to some embodiment. FIG. 2B shows an implementation of controller 170 (270 in FIG. 2A and FIG. 2B) for the purpose of data and instructions exchange among sample introduction device 130 (step 230), ion source 140 (step 240), IMSD 150 (step 250), and mass analyzer 160 (step 260) according to some embodiments.

As shown in FIG. 1, FIG. 2A, and FIG. 2B, the controller is configured to coordinate the extraction of the samples from the reservoirs and the activation of at least one control parameter of IMSD 150 (step 250) for the detection of a target analyte within a particular sample, as discussed in more detail below. Controller 270 may also control the operation of the sample introduction device 130 (step 230), ion source 140 (step 240) and mass analyzer 160 (step 260) as shown in FIG. 2B.

As mentioned above, in some embodiments, the IMSD may include a Differential Mobility Spectrometer (DMS). In some embodiments, the DMS may include a planar differential mobility spectrometer or a high field asymmetric waveform ion mobility spectrometer (conventionally referred to as FAIMS), both of which rely on the change in the ion mobility of an ion when it is subjected to a high electric field versus a low electric field range.

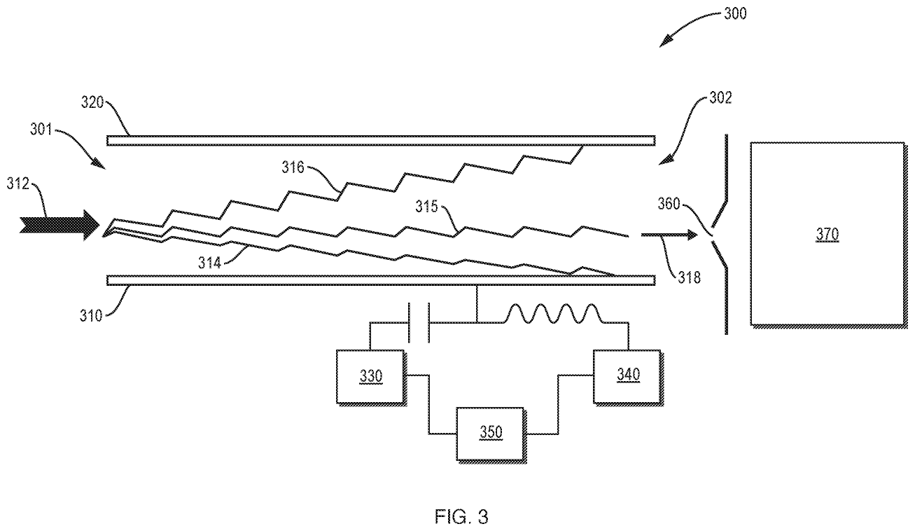

FIG. 3 shows a schematic of a DMS 300 utilized in combination with a mass analyzer 370 according to some embodiments. DMS 300 includes a first planar electrode 310, a second planar electrode 320, a separation voltage source (SV source 330), a compensation voltage source (CoV source 340), a controller 350, and an orifice 360. FIG. 3 further illustrates an entrance area 301 and an exit area 302 for DMS 300, a transport gas flow 312, traces of two deflected ions 314 and 316, a trace of a non-deflected ion, i.e., a targeted ion 315, and an exiting ion beam 318.

First planar electrode 310 and second planar electrode 320 may be conductive plates. Moreover, SV source 330 may be a source of a time dependent electric potential, configured to generate an alternating voltage called the separation voltage (SV). Further, CoV source 340 may be another source of electric potential, configured to generate a DC voltage called the compensation voltage (CoV).

Moreover, controller 350 may be a module that is connected to, and configured to control the operation of, some parts of DMS 300, such as one or more of SV source 330 and CoV source 340. Controller 350 may, for example, control parameters such as one or more of the time dependent magnitude and frequency of SV, the time dependence and magnitude of CoV, and the composition and volumetric flow rate of transport gas flow 312. The application of the electric potentials SV and COV to at least one DMS filter, in this case first planar electrode 310, may thus generate a time dependent electric field inside DMS 300, that is, in the space between the two conductive plates 310 and 320. During the operation of DMS 300, controller 350 may control different parameters such as SV, CoV, or temperature such that the resulting electric field filters out some of the ions and selects some other ions as target ions, as further described below.

In some embodiments, transport gas flow 312 may result from a pressure difference, that is, a decreasing pressure between the entrance area and the exit area, thus causing the transport gas flow in that direction toward the orifice. In some embodiments, the pressure difference exists because the DMS is maintained at the atmospheric pressure while the downstream orifice 360 is sealed to a first chamber of mass analyzer 370, which is maintained at a first vacuum stage with a pressure that is lower than the atmospheric pressure.

During the operation of DMS 300, ions that arrive at entrance area 301 of the DMS may be driven by transport gas flow 312 toward exit area 302, and filtered via the time dependent electric field inside the DMS. In particular, to perform the filtering, controller 350 may adjust the parameters of SV, COV, temperature, transport gas flow rate, or transport gas composition such that some of the ions are deflected by the electric field toward one of the two plates, and neutralized on that plate; while other ions, the targeted ions, reach exit area 302 and pass through orifice 360 into mass analyzer 370. The schematic in FIG. 3 illustrates three such ions by showing their traces. More specifically, FIG. 3 illustrates that the time dependent electric field deflects ion 314 toward first planar electrode 310 and causes that ion to be neutralized on first planar electrode 310 before reaching exit area 302. Similarly, the time dependent electric field deflects ion 316 toward second planar electrode 320 and causes that ion to be neutralized on second planar electrode 320 before reaching exit area 302. On the other hand, the time dependent electric field causes the third ion, targeted ion 315, to remain between the two plates, reach exit area 302, pass through orifice 360, and eventually reach mass analyzer 370. The collection of such exiting targeted ions generate exiting ion beam 318.

The behavior of an ion inside DMS 300, that is, whether or not the ion is deflected toward one of the plates may depend upon the field dependent ion mobility behavior of the ion, for example, a change of the mobility coefficient of the ion in a high intensity field versus a low intensity field. That behavior may also depend upon some other factors such as the SV amplitude or waveform shape, the transport gas composition, and the temperature or pressure of the transport gas flow. The mobility coefficient of the ion may in turn depend on one or more physical characteristics of the ion such as its cross section, shape, effective mass, charge, and ion molecule effects such as clustering and polarization. These physical characteristics may affect the radial speed of the ions. Controller 350 may accordingly set the characteristics of the time dependent SV, the DC voltage CoV, or the transport gas flow such that the targeted ions are selected to pass through the DMS, while the non-targeted ions are deflected and neutralized on the plates.

In some embodiments, a high throughput mass analysis system with improved duty cycle may be provided. The controller may be configured to set a mass range for analysis by the mass analyzer based upon an operational state of the IMSD.

In some embodiments, the operational state comprises a transmission window of IMSD 150. In some embodiments, the operational state of IMSD 150 comprises a drift time, ion mobility, or collision cross section value determined using IMSD 150.

Controller 170 accordingly determines a mass range for mass analyzer 160 according to these embodiments. In some embodiments, the mass range for analysis may include ion masses within the transmission window. In some embodiments, the mass range for analysis may include expected fragments to be generated by mass analyzer 160 for an ion within the transmission window. For instance, mass analyzer 160 may include multiple stages of mass analysis and one or more regions for ion dissociation.

In some embodiments, controller 170 is operative to receive sampling event information from sample introduction device 130 and to set operational parameters of at least one of IMSD 150 and mass analyzer 160 in coordination with the sampling event information. In some embodiments these operational parameters may change at a rate of 1 Hz or greater.

In some embodiments, controller 170 is operative to receive sampling event information from sample introduction device 130 and IMSD 150 to set operational parameters for mass analyzer 160.

In some embodiments, controller 170 is operative to receive sampling event information from sample introduction device 130 and mass analyzer 160 to set operational parameters for IMSD 150. For instance, having a mass range provided by mass analyzer 160 will be beneficial for IMSD 150 as it may significantly reduce the amount of time needed for an IMS or DMS device to analyze an ion as described above.

In some embodiments, controller 170 is operative to store the sampling event information in association with analysis results generated by mass analyzer 160 in order to associate specific analysis results with a sampling event and/or a sample being sampled.

In some embodiments, controller 170 may be operative to coordinate an operational state of mass analyzer 160 based upon a sample being sampled by sample introduction device 130, an operational state of sample introduction device 130, an operational state of IMSD 150, or a combination thereof. The operational state of mass analyzer 160 may include control, for instance, of components that may include a mass filter, an ion trap, a collision cell, a dissociation cell, an accelerator, a detector, a ToF pulser, or other mass analyzer elements to switch the operational state of mass analyzer 160.

In some embodiments, controller 170 may be operative to coordinate an operational state of the mass analyzer 160 based upon a timing of a sampling event performed by sample introduction device 130, an operational state of sample introduction device 130, an operational state of IMSD 150, or a combination thereof. The operational state of mass analyzer 160 may include control, for instance, of components that may include a mass filter, an ion trap, a collision cell, a dissociation cell, an accelerator, a detector, a ToF pulser, or other mass spectrometer element, to switch the operational state of mass analyzer 160 in coordination with the sampling event to match the timing of mass analyzer 160 with an expected arrival of ions to mass analyzer 160 corresponding to the sampling event.

In some embodiments, mass analyzer 160 is a time-of-flight (ToF) mass spectrometer and controller 170 may be operative to coordinate analysis results produced by the ToF mass spectrometer based on a timing of a sampling event performed by sample introduction device 130, an operational state of the sample introduction device 130, an operational state of IMSD 150, or a combination thereof, and a timing of the ToF pulser.

In some embodiments, controller 170 is operative to coordinate the analysis results by associating sample information or system information with the timing of the ToF pulser. In some embodiments, controller 170 is operative to record the association in a data file. The data file may include the analysis results generated by the ToF mass spectrometer.

In some embodiments, controller 170 is operative to coordinate operation of at least two of: sample introduction device 130, ion source 140, IMSD 150 and mass analyzer 160. The IMSD may include, for instance, a differential mobility spectrometer (DMS), differential mobility analyzer (DMA), an ion mobility spectrometer (IMS), or other continuous separation device for selectively transmitting ions. The mass analyzer may be any conventional mass spectrometer including a time-of-flight mass spectrometer, triple quadrupole mass spectrometer, or ion trap mass spectrometer.

In some embodiments, devices and methods utilize an acoustic open port interface device with two downstream separation dimensions, the first dimension corresponding to IMSD 150, being either the DMS or the IMS and the second dimension corresponding to mass analyzer 160, being the MS. In these embodiments, the approach includes an acoustic ejection device that provides a trigger for each ejection. The trigger controls the start of the IMSD. In some embodiments, an additional delay time may be incorporated after the trigger to correct for possible additional time delays due to transfer of ions from the acoustic device to the IMSD.

In some embodiments, controller 170 uses the parameter settings of IMSD 150 to define a smaller subset of the mass range for mass analyzer 160. For instance, mobility drift time or cross section provides information that correlates well with the mass of the ions of interest. This may trigger mass analyzer to analyze a particular range that may be reduced from the normal range. As another example, there may be a correlation between mobility and mass for charged particles. The mobility correlates to drift time in the IMS and therefore drift time information may be used to reduce the total mass analysis range to a small m/z range.

In addition, DMS behavior may also be coordinated with m/z. For instance, in dry nitrogen transport gas, ions with m/z less than 200 typically exhibit Type B behavior, in which, as the separation voltage (separation field) increases, the compensation voltage for the ion passing through decreases first and then increases. When this behavior is observed, there is no need to waste analytical time by having the mass analyzer scan higher than m/z of 200. Conversely, multiply charged peptides may typically exhibit Type C behavior with mobility, decreasing with electric field, and have very large positive CoV values in nitrogen transport gas (Peptides may contain multiple charges (e.g. +2, +3, etc.) through the electrospray ionization source). When these large positive CoV values are observed, the mass analyzer may be controlled to cover an m/z range consistent with multiple charge peptides (e.g. m/z greater than 400). In various embodiments, the magnitude of the large positive CoV values may be directly proportional to the magnitude of the separation voltage. These examples are not meant to be limiting and it is possible to correlate DMS or IMS behavior to various other m/z ranges and types of samples as well.

In one embodiment, for example, from a panel of approximately 200 compounds, the maximum negative CoV values may be −50 V at m/z of 300 and −15 V at m/z of 650, when using SV equal to 3500 V and a 1 mm spacing between the DMS electrodes. For an analysis system that ramps the CoV from 0 to −70 V while scanning m/z from 100 to 1000 V, the duty cycle may be significantly improved by adjusting the m/z scan or analysis range as a result of the CoV values. As an example, if the CoV ramp starts at −70 V, the mass analyzer may be scanned from 100 to 300 m/z rather than from 100 to 1000 m/z. Accordingly, the mass scan range may widen as the CoV increases toward 0, permitting maximum throughput according to these embodiments. In some embodiments the m/z range of the analyzer may also be reduced based upon the IMS or DMS parameter values.

When running DMS with chemical modifiers such as IPA, the magnitude of the negative CoV shift upon clustering may depend upon the relative mass of the ion of interest and the modifier. The lowest m/z ions shift to the largest negative CoV values. This relationship may be used in a fashion similar to the IMS approach described above.

According to some embodiments, controller 170 selects (sets) mass ranges of mass analyzer 160 to specifically coincide with 1) a sample introduced by sample introduction device 130 and 2) the operational parameters of IMSD 150. In some embodiments, mass analyzer 160 may be operated with a mass range tailored to expected analytes of interest based on the sample being introduced and selection provided by IMSD 150.

For systems that incorporate an IMS, the control parameters may include different parameters, including but not limited to voltage amplitudes applied to specific lens elements, potential gradients, travelling wave potential amplitude and ramp rates, travelling wave speed, gas composition, number of cycles in the case of a cyclic IMS, drift tube length details, control voltages for directing ions along parallel IMS devices for instance with different lengths, gating times for shutters before, after, or within IMS devices to select a small subset of ions passing through, in addition to control info for a downstream mass analyzer to correlate one or more scan types or m/z measurement regions with IMS separation time and/or delay time resulting from transfer of ions through one or more regions, including an OPI, an IMS, and any other region.

Smaller ions typically have higher mobility and as a result in an IMS they drift at a higher speed than larger ions. Therefore, in some embodiments, it may be useful to change the m/z range of the mass analyzer at different times from the start of an IMS experiment. During a first time window from the start of an IMS separation, a lower m/z window may be monitored by the mass analyzer and during a later time window, a higher m/z window may be monitored to account for the difference in drift time for small (high mobility) vs large (lower mobility) ions. The reduction of the m/z scan range of a mass analyzer may improve sampling throughput. Similar approaches may be used with non-scanning mass analyzers such as selective monitoring of Multiple Reaction Monitoring (MRM) transitions, for instance, on triple quadrupole mass spectrometers. For instance, in an analysis where it is desirable to monitor 10 different MRM transitions with parent m/z values ranging from m/z 100 to 1000, monitoring each of the 10 transitions for every analysis cycle limits the number of measurement points across a peak. Substantially more measurements could be achieved for a given sample by monitoring only the MRM transitions that correspond to a mass range consistent with the upstream mobility results.

In some embodiments, controller 170 may send control signals indicating the values of the separation voltage, the compensation voltage, and the offset voltage suitable for identification of the ions associated with the target compound to a DMS.

In various embodiments, one or more of disclosed modules, such as controller 170, may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud,” to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory. Further, in various embodiments, one or more of the storage media may be non-transitory computer-readable media that store data or computer programs executed by various modules, or implement various techniques or flow charts disclosed herein.

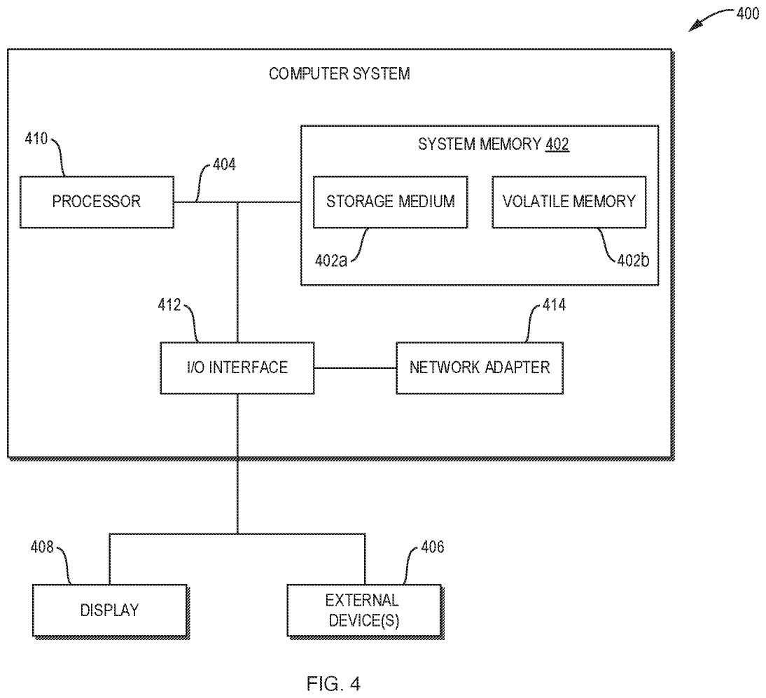

By way of example, FIG. 4 schematically depicts an example of an implementation of a module 400 according to some embodiments. Module 400 includes a processor 410 (e.g., a microprocessor), a system memory 402 including at least one permanent memory module (e.g., storage medium 402a) and at least one transient memory module (e.g., volatile memory 402b) a bus 404, and an I/O interface 412. System memory 402 may be utilized to store and execute instructions performing the function of module 400. Moreover, bus 404 may allow communication between the processor and various other components of the module. I/O interface 412 may be configured to allow sending and receiving signals. Network adapter 414 enables I/O interfaces 412 to communicate, e.g. over a local area network (LAN), connecting to the internet or to other components, devices, and computers. In this example, I/O interface 412 is in network communication with devices such as the display 408 and external devices 406.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A system for performing high throughput mass spectrometry, the system comprising:
a controller configured to select a first set of system parameter values and determine a second set of system parameter values based on the first set of system parameter values, wherein:
the first set of system parameter values is a set of mobility parameter values or a range of mass values, and
the second set of system parameter values is:
the set of mobility parameter values or the range of mass values, and different from the first set of system parameter values;
an ion mobility separation device (IMSD) configured to:
receive a plurality of ions from an upstream ion source;
receive the set of mobility parameter values from the controller; and
perform an ejection of a set of target ions of the plurality of ions by adjusting a set of mobility control parameters to the set of mobility parameter values; and
a mass analyzer positioned downstream of the IMSD and configured to:
receive the set of target ions;
receive the range of mass values from the controller; and
analyze the set of target ions by scanning the range of mass values or stepping across the range of mass values.

2. The system of claim 1, wherein the controller is configured to select the set of mobility parameter values and determine the range of mass values based on the set of mobility parameter values, and
wherein, optionally, the controller is configured to update the range of mass values based on a change in the at least one of the set of mobility parameter values.

3. The system of claim 2, wherein the set of mobility parameter values includes at least one of a transmission window, a drift time, an ion mobility, a voltage, a differential ion mobility, a compensation voltage, a collision cross-section, a transport time, a gas flow rate, a gas composition, and a temperature of ions passing through the ion mobility separation device.

4. The system of claim 3, wherein the range of mass values includes one of ion masses within the transmission window, and expected fragments to be generated by the mass analyzer, and
wherein, optionally, the controller is configured to utilize calibration data corresponding to a correlation between the compensation voltage and an ion mass to compute the range of mass values or mobility values.

5. (canceled)

6. The system of claim 2, wherein the controller is configured to cause application of RF or DC voltages to the mass analyzer for setting the range of mass values.

7. (canceled)

8. The system of claim 1, wherein the controller is configured to select the range of mass values and determine the set of mobility parameter values based on the range of mass values.

9. The system of claim 1, wherein the range of mass values include a first large range of mass or MRM transitions of interest and the at least one of the first or second set of parameters includes a smaller subset.

10. The system of claim 1, wherein the IMSD comprises one of an ion mobility spectrometer and a differential mobility spectrometer, or wherein the mass analyzer is selected from a quadrupole mass analyzer, a time-of-flight mass analyzer, and an ion trap mass analyzer.

11. (canceled)

12. The system of claim 1, further comprising a sample introduction device for introducing a sample into an upstream ion source, wherein, optionally, the sample introduction device comprises an open port interface (OPI).

13. (canceled)

14. A method of performing high throughput mass spectrometry, the method comprising:
introducing a plurality of ions into an ion mobility separation device (IMSD), adjusting at least one operational parameter of the IMSD to separate the plurality of ions based on ion mobility, and
setting a mass range of a downstream mass analyzer configured to receive ions passing through the IMSD based on the at least one operation parameter of the ion mobility separation device.

15. The method of claim 14, wherein setting the mass range of the downstream mass analyzer comprises utilizing calibration data indicative of a correlation between the at least one operational parameter of the IMSD and mass values of ions passing through the IMSD.

16. A method of performing high throughput mass spectrometry, the method comprising:
selecting, by a controller, a first set of system parameter values;
determining, by the controller, a second set of system parameter values based on the first set of system parameter values, wherein:
the first set of system parameter values is a set of mobility parameter values or a range of mass values, and
the second set of system parameter values is:
the set of mobility parameter values or the range of mass values, and different from the first set of system parameter values;
receiving, by an ion mobility separation device (IMSD), a plurality of ions from an upstream ion source;
performing an ejection of a set of target ions of the plurality of ions by adjusting a set of mobility control parameters to the set of mobility parameter values;
receiving, by a mass analyzer, the set of target ions; and
analyzing, by the mass analyzer, the set of target ions by scanning the range of mass values or stepping across the range of mass values.

17. The method of claim 16, wherein the controller is configured to select the set of mobility parameter values and determine the range of mass values based on the set of mobility parameter values, and
wherein, optionally, the controller is configured to update the range of mass values based on a change in the at least one of the set of mobility parameter values.

18. The method of claim 17, wherein the set of mobility parameter values includes at least one of a transmission window, a drift time, an ion mobility, a voltage, a differential ion mobility, a compensation voltage, a collision cross-section, a transport time, a gas flow rate, a gas composition, and a temperature of ions passing through the ion mobility separation device.

19. The method of claim 18, wherein the range of mass values includes one of ion masses within the transmission window, and expected fragments to be generated by the mass analyzer, and
wherein, optionally, the controller is configured to utilize calibration data corresponding to a correlation between the compensation voltage and an ion mass to compute the range of mass values or mobility values.

20. (canceled)

21. The method of claim 17, wherein the controller is configured to cause application of RF or DC voltages to the mass analyzer for setting the range of mass values.

22. (canceled)

23. The method of claim 16, wherein the controller is configured to select the range of mass values and determine the set of mobility parameter values based on the range of mass values.

24. The method of claim 16, wherein the range of mass values include a first large range of mass or MRM transitions of interest and the at least one of the first or second set of parameters includes a smaller subset.

25. The method of claim 16, wherein the IMSD comprises one of an ion mobility spectrometer and a differential mobility spectrometer, or wherein the mass analyzer is selected from a quadrupole mass analyzer, a time-of-flight mass analyzer, and an ion trap mass analyzer.

26. (canceled)

27. The method of claim 16, further comprising a sample introduction device for introducing a sample into an upstream ion source,
wherein, optionally, the sample introduction device comprises an open port interface (OPI).

28. (canceled)
